(19) United States
(12) Patent Application Publication
(10) Pub. No.: US 2006/0090830 A1
(43) Pub. Date: May 4, 2006

(54) Extended-mobility tire comprising a plurality of impermeable layers

(75) Inventors: David Jardine, Clermont-Ferrand (FR); Thierry Royer, La Roche Blanche (FR); Christian Chauffour, Clermont-Ferrand (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MICHELIN RECHERCHE ET TECHNIQUE S.A.

(21) Appl. No.: 11/254,859

(22) Filed: Oct. 21, 2005

Related U.S. Application Data
(63) Continuation of application No. PCT/EP04/04032, filed on Apr. 16, 2004.

(30) Foreign Application Priority Data
Apr. 25, 2003 (FR) 03/05214

(51) Int. Cl. B60C 17/00; B60C 15/00; B60C 5/14; B60C 1/00

(52) U.S. Cl. 152/510; 152/517; 152/565; 152/547; 152/539; 152/550

(57) ABSTRACT

A tire suitable for extended-mobility travel, comprising a carcass-type reinforcement structure anchored on each side of said tire in a bead, each of the beads furthermore comprising an anchoring zone for holding the reinforcement structure, each of said sidewalls being reinforced by a sidewall insert formed of rubber composition capable of bearing a load corresponding to part of the weight of the vehicle in a situation in which the inflation pressure is substantially reduced or zero, said tire furthermore comprising an inner layer formed of a rubber composition substantially impermeable to the inflation gas covering substantially the entire interior of said tire, from one sidewall to the other, a bonding layer being arranged between said sidewall insert and said inner layer. Said inner layer is advantageously formed of a rubber composition based on butyl rubber, whereas said bonding layer is preferably formed of a rubber composition based on natural rubber or on synthetic polyisoprene having a high cis-1,4 linkage content.

The present application is a continuation of International Application No. PCT/EP2004/004032, filed Apr. 16, 2004, published in French on Nov. 11, 2004 as WO 2004/096584, claiming priority of French Application No. 03/05214, filed Apr. 25, 2003.

### STATEMENT OF RELATED ART

The present invention relates to a extended-mobility tire of the self-supporting sidewall type, having optimum impermeability characteristics.

For some years, tire manufacturers have been devoting considerable effort to developing original solutions to a problem dating back to the very first time use was made of wheels fitted with tires of the inflated type, namely how to allow the vehicle to continue on its journey despite a considerable or total loss of pressure in one or more tires. For decades, the spare wheel was considered to be the sole, universal solution. Then, more recently, the considerable advantages linked to the possible elimination thereof have become apparent. The concept of “extended mobility” is being developed. The associated techniques allow travel to continue with the same tire, within certain limits, after a puncture or a drop in pressure. This allows the driver to travel to a repair point, for example, without having to stop, in frequently dangerous circumstances, to fit the spare wheel.

Two major types of extended-mobility technology are currently available on the automobile market. On the one hand, there are tires of the self-supporting type (often known by their English abbreviation ZP, standing for “zero pressure”). Self-supporting tires are capable of bearing a load under reduced pressure, or indeed without pressure, thanks to sidewalls which are reinforced, most frequently by means of inserts of rubber material, provided in the sidewalls.

On the other hand, wheels are available which are equipped with supports capable of supporting the inside of the tread of a tire in the event of sagging of the sidewalls following a drop in pressure. This solution is advantageously combined with a tire comprising a bottom zone capable of minimizing the risk of the tire sliding out of the rim. This solution is advantageous since it makes it possible to keep substantially intact the characteristics of travel under normal conditions. On the other hand, it has the drawback of requiring an additional component, the support, for each of the wheels of the vehicle.

In order to produce tires having self-supporting sidewalls of a high level of quality and reliability, it is desirable to be able to provide a high level of impermeability, firstly in order to make it possible to minimize the losses of pressure over time, and secondly in order to create an anti-oxygen barrier making it possible to protect the various constituent elements of the tire. In the former case, it is a question of the comfort of use of the product, which advantageously maintains a constant pressure over weeks and months. According to the other aspect, the sources and risks of oxidation of one or the other of the numerous architectural elements of the tire are minimized.

However, in the case of tires having self-supporting sidewalls, the presence in the sidewalls of high-rigidity inserts, which occupy a relatively large portion of the sidewalls, may make it awkward to position an impermeable layer, the rigidity of which is substantially less than that of the insert, because due to the very different nature of the mixes used to produce the inserts on one hand, and the impermeable layer on the other hand, there may result a large degree of heterogeneity at the interface zones between such materials. Furthermore, in order to obtain the high levels of impermeability mentioned, it is difficult to conceive of compromise, be it in terms of the nature of the impermeable layer or its positioning relative to the other architectural elements.

### SUMMARY OF THE INVENTION

To overcome these various drawbacks, the invention proposes a tire suitable for extended-mobility travel, comprising at least one carcass-type reinforcement structure anchored on each side of said tire in a bead the base of which is intended to be mounted on a rim seat, each of said beads extending substantially radially externally in the form of sidewalls, the sidewalls radially towards the outside joining a tread, the carcass-type reinforcement structure extending circumferentially from the bead towards said sidewall, a crown reinforcement, each of the beads furthermore comprising an anchoring zone permitting the reinforcement structure to be held, each of said sidewalls being reinforced by a sidewall insert formed of rubber composition capable of bearing a load corresponding to part of the weight of the vehicle in a situation in which the inflation pressure is substantially reduced or zero, said tire furthermore comprising an inner layer formed of a rubber composition substantially impermeable to the inflation gas covering substantially the entire interior of said tire, from one sidewall to the other, a bonding layer formed of a rubber composition being arranged between each of said sidewall inserts and said inner layer.

A very high level of impermeability is achieved owing to the presence of the impermeable layer (preferably based on butyl rubber). The positioning of this layer in the innermost position of the walls makes it possible to protect all the other layers and elements of the walls, for example from diffusion of oxygen.

The bonding layer, for its part, provides a progressive rigidity gradient between the impermeable layer and the insert. Thus better holding of the unit and durable and reliable assembly is obtained. The interface between the impermeable layer and the sidewall insert is optimised. The mechanical stresses, which are extremely high in particular when travelling at reduced or zero pressure, are absorbed and distributed better.

The presence of the bonding layer, which is less rigid than the insert, furthermore provides additional protection for the insert, which is less resistant than the bonding layer to high mechanical stresses. The bonding layer is also particularly advantageous because it has a satisfactory ability to fix oxygen even at high temperatures such as running temperatures (that is to say, under conditions of thermo-oxidising ageing), thus constituting a barrier to the migration of any oxygen having passed through the inner layer.

### BRIEF DESCRIPTION OF THE DRAWINGS

FIG. 1 illustrates a radial section showing a bead, a sidewall, and half of the crown of an example of an embodiment of a first type of tire according to the invention.

FIG. 2 illustrates a radial section showing a bead, a sidewall, and half of the crown of an example of an embodiment of a second type of tire according to the invention.

FIG. 3 illustrates a radial section showing a bead, a sidewall, and half of the crown of an example of an embodiment of another type of tire according to the invention.

FIG. 4 illustrates a radial section showing a bead, a sidewall, and half of the crown of an example of an embodiment of another type of tire according to the invention.

FIG. 5 illustrates a radial section showing a bead, a sidewall, and half of the crown of an example of another embodiment of a type of tire according to the invention.

### DETAILED DESCRIPTION OF THE INVENTION

According to one advantageous embodiment, the inner layer (preferably based on butyl rubber) is extended along the sidewall radially internally to a level located in the junction zone between the radially inner portion of the sidewall insert and the radially outer portion of the anchoring zone. The presence of the impermeable layer against substantially the entire surface of the insert makes it possible to provide the high level of impermeability which is desired. The presence of this layer which is substantially more flexible, and hence less fragile than the insert itself, provides effective protection for said insert.

The bonding layer is preferably in direct contact with firstly said inner layer and secondly said insert. This direct contact enables it to act as an interface both with the insert and with the impermeable layer, establishing a zone having mechanical properties which are intermediate between these two elements.

According to one example of embodiment of the invention, said bonding layer extends between the bead and the shoulder zone. This corresponds substantially to the surface of the insert. According to another example of embodiment of the invention, said bonding layer covers a surface which is substantially identical to that of the inner layer.

According to one advantageous embodiment, one end portion of said inner layer is anchored in the corresponding bead. Thus protection against incipient separation is obtained.

Advantageously, said sidewall insert is arranged axially internally relative to said reinforcement structure. The reinforcement structure is then arranged axially externally, thus optimising its course in the tension zone. This is particularly beneficial in terms of endurance.

According to one advantageous embodiment, an intermediate layer of rubber composition is arranged between said sidewall insert and said reinforcement structure. The presence of this intermediate layer permits better deradialisation of the reinforcing threads of the reinforcement structure in the zone of contact with the ground, resulting in better comfort and better endurance. Said intermediate layer is advantageously formed of a rubber composition of a nature similar to that of said bonding layer. This is a solution which is economical and simple to carry out. The positioning of the insert, which is “floating” to some extent, imparts increased comfort and optimum endurance.

According to one advantageous embodiment of the invention, said bonding layer is formed of a rubber composition having a secant modulus of extension ME10 at 10% deformation, measured at 23° C. in accordance with Standard ASTM D 412, of from 2 to 4 MPa.

According to one advantageous embodiment of the tire according to the invention, each of said sidewall inserts is preferably formed of a rubber composition having a secant modulus of extension ME10 at 10% deformation, measured at 23° C. in accordance with Standard ASTM D 412, of from 5 to 13 MPa.

On the other hand, said inner layer is preferably formed of a rubber composition having a secant modulus of extension ME10 at 10% deformation, measured at 23° C. in accordance with Standard ASTM D 412, of from 1.5 to 3.5 MPa.

Advantageously, the rubber composition of said intermediate layer has a secant modulus of extension ME10 at 10% deformation, measured at 23° C. in accordance with Standard ASTM D 412, of from 2 to 4 MPa.

According to one advantageous embodiment, the rubber composition of said bonding layer is based on one or more diene elastomers the molar ratio of units originating from conjugated dienes of which is at least equal to 30%.

The expression “based on” is understood in known manner to mean that the constituent which follows is present in the composition in a majority proportion.

“Diene elastomer” is understood to mean, in known manner, an elastomer (homopolymer or copolymer) originating at least in part from diene monomers (monomers bearing two double carbon-carbon bonds, whether conjugated or not). “Diene elastomer, the molar ratio of units originating from conjugated dienes of which is at least equal to 30%” (such a diene elastomer is conventionally referred to as “essentially unsaturated” by the person skilled in the art), is used to rule out diene elastomers such as butyl rubbers, nitrile rubbers or copolymers of dienes and alpha-olefins of EPDM type, which are not usable in the bonding-layer or intermediate-layer compositions according to the invention owing to their reduced molar ratio (less than 15%) of units originating from dienes.

Preferably, the composition of said bonding layer and possibly that of said intermediate layer is based on at least one “highly unsaturated” diene elastomer, that is to say a diene elastomer having a molar ratio of units originating from conjugated dienes which is greater than 50%.

By way of “highly saturated” diene elastomer usable in the bonding-layer and possibly intermediate-layer compositions according to the invention, natural rubber and/or:

a homopolymer obtained by polymerization of a conjugated diene monomer having 4 to 12 carbon atoms, or

a copolymer obtained by copolymerization of one or more conjugated dienes together or with one or more vinyl-aromatic compounds having from 8 to 20 carbon atoms, may be used.

Suitable conjugated dienes are, in particular, 1,3-butadiene, 2-methyl-1,3-butadiene, 2,3-di(C1 to C5 alkyl)-1,3-butadienes such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene.

Suitable vinyl-aromatic compounds are, for example, styrene, ortho-, meta- and para-methylstyrene, the commercial mixture “vinyltoluene”, para-tert. butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl-aromatic units.

Even more preferably, the diene elastomer(s) of the bonding-layer composition and possibly of the intermediate-layer composition according to the invention are selected from the group of “highly unsaturated” diene elastomers consisting of natural rubber, polybutadienes (BR), synthetic polyisoprenes (IR) having a high cis-1,4 linkage content, butadiene/styrene copolymers (SBR), butadiene/isoprene copolymers (BIR), isoprene/styrene copolymers (SIR), butadiene/styrene/isoprene copolymers (SBIR) or a mixture of two or more of these compounds.

Even more preferably, the rubber composition of said bonding layer comprises (phr: parts by weight per hundred parts of elastomer(s)):
from 40 to 100 phr of natural rubber or of a synthetic polyisoprene having a high cis-1,4 linkage content, and
from 60 to 0 phr of a polybutadiene and/or of a copolymer of butadiene and a vinyl-aromatic monomer, such as a styrene/butadiene copolymer.

Furthermore the rubber composition of said bonding layer advantageously comprises:
from 55 to 100 phr of said natural rubber or of said synthetic polyisoprene, and
from 45 to 0 phr of said polybutadiene and/or said butadiene copolymer.

Preferably, the rubber composition of said bonding layer comprises a reinforcing filler comprising carbon black or a blend of carbon black and a reinforcing inorganic filler, such as silica.

Suitable carbon blacks are all the carbon blacks conventionally used in tires, and advantageously those of grade 6, such as the black N660.

“Reinforcing inorganic filler”, in known manner, is understood to mean an inorganic or mineral filler, whatever its color and its origin (natural or synthetic), also referred to as “white” filler or sometimes “clear” filler in contrast to carbon black, this inorganic filler being capable, on its own, without any other means than an intermediate coupling agent, of reinforcing a rubber composition intended for the manufacture of tires, in other words which is capable of replacing a conventional tire-grade carbon black filler in its reinforcement function.

Advantageously, the entirety or at the very least a majority proportion of said reinforcing inorganic filler is silica (SiO₂). The silica used may be any reinforcing silica known to the person skilled in the art, in particular any precipitated or fumed silica having a BET surface area and a CTAB specific surface area both of which are less than 450 m²/g, even if the highly dispersible precipitated silicas are preferred.

In the present specification, the BET specific surface area is determined in known manner, in accordance with the method of Brunauer, Emmet and Teller described in “The Journal of the American Chemical Society”, vol. 60, page 309, February 1938, and corresponding to Standard AFNOR-NFT-45007 (November 1987); the CTAB specific surface area is the external surface area determined in accordance with the same Standard AFNOR-NFT-45007 of November 1987.

“Highly dispersible silica” is understood to mean any silica having a very substantial ability to disagglomerate and to disperse in an elastomer matrix, which can be observed in known manner by electron or optical microscopy on thin sections. As non-limitative examples of such preferred highly dispersible silicas, mention may be made of the silicas Ultrasil 7000 and Ultrasil 7005 from Degussa, the silicas Zeosil 1165MP, 1135MP and 1115MP from Rhodia, the silica Hi-Sil EZ150G from PPG, the silicas Zeopol 8715, 8745 and 8755 from Huber, and treated precipitated silicas such as, for example, the aluminum-“doped” silicas described in application EP-A-735 088.

For example, black/silica blends or blacks partially or entirely covered with silica are suitable to form the reinforcing filler. Also suitable are reinforcing inorganic fillers comprising carbon blacks modified by silica such as, although this is not limiting, the fillers sold by CABOT under the name “CRX 2000”, which are described in International Patent Specification WO-A-96/37547.

As reinforcing inorganic filler, it is also possible to use, although this is not limiting, aluminas (of formula Al₂O₃), such as the high-dispersibility aluminas which are described in European patent specification EP-A-810 258, or alternatively aluminum hydroxides, such as those described in international patent specification WO-A-99/28376.

In the case in which a reinforcing inorganic filler, such as silica, is used in the rubber composition of the bonding layer and possibly in that of the intermediate layer, these compositions according to the invention may furthermore conventionally comprise a reinforcing inorganic filler/elastomeric matrix bonding agent (also referred to as coupling agent), the function of which is to ensure sufficient chemical and/or physical bonding (or coupling) between said inorganic filler and the matrix, while facilitating the dispersion of this inorganic filler within said matrix.

“Coupling agent” is more precisely understood to mean an agent capable of establishing a sufficient chemical and/or physical connection between the filler in question and the elastomer, while facilitating the dispersion of this filler within the elastomeric matrix. Such a coupling agent, which is at least bifunctional, has, for example, the simplified general formula “Y-T-X”, in which:
Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica);
X represents a functional group (“X” function) which is capable of bonding physically and/or chemically with the elastomer, for example by means of a sulphur atom;
T represents a group making it possible to link Y and X.

The rubber compositions according to the invention also comprise, in addition to the diene elastomer(s) and the reinforcing filler (and possibly said bonding agent in the event of a reinforcing inorganic filler such as silica being present), an antioxidant, an antiozone wax, a cross-linking system for example based on sulphur and cross-linking activators comprising for example zinc monoxide and stearic acid.

Advantageously, the rubber composition of said bonding layer comprises sulphur in a quantity equal to or greater than 2 phr (phr: parts by weight per hundred parts of elastomer(s)).

The rubber composition of said bonding layer preferably comprises a metal salt intended to activate oxidation in this composition by trapping oxygen. Said salt is advantageously an iron (III) salt belonging to the group consisting of iron (III) acetylacetonate, iron (III) salts of carboxylic acids of formula Fe(CₙH₂ₙO₂)₃ where n is between 2 and 23, and iron (III) salts of an aromatic mono-carboxylic acid comprising one or more aromatic rings. Said iron (III) salt is preferably present in the rubber composition of said bonding layer in a quantity of from 0.01 phr to 0.03 phr.

According to another variant, said salt is a cobalt salt, such as cobalt naphthenate. Said cobalt salt is present in the rubber composition of said bonding layer in a quantity of from 0.1 phr to 0.3 phr.

The rubber composition of each of said inserts preferably comprises (phr: parts by weight per hundred parts of elastomer(s)):
from 20 to 100 phr of natural rubber or of a synthetic polyisoprene having a high cis-1,4 linkage content, and
from 80 to 0 phr of a polybutadiene and/or of a copolymer of butadiene and a vinyl-aromatic monomer, such as a styrene/butadiene copolymer.

Advantageously, the rubber composition of each of said inserts comprises:
from 20 to 50 phr of natural rubber or of a synthetic polyisoprene having a high cis-1,4 linkage content, and
from 80 to 50 phr of a polybutadiene and/or of a copolymer of butadiene and a vinyl-aromatic monomer, such as a styrene/butadiene copolymer.

Preferably, the rubber composition of said inner layer comprises:
from 40 to 100 phr of at least one elastomer belonging to the group consisting of butyl rubbers, halogenated butyl rubbers and paramethylstyrene/isobutylene copolymers, and
from 60 to 0 phr of natural rubber or of a synthetic polyisoprene having a high cis-1,4 linkage content, and/or of a copolymer of butadiene and a vinyl-aromatic monomer, such as a styrene/butadiene copolymer.

The rubber composition of said intermediate layer is preferably based on one or more diene elastomers, the molar ratio of units originating from conjugated dienes of which is at least equal to 30%. Furthermore the rubber composition of said intermediate layer preferably comprises (phr: parts by weight per hundred parts of elastomer(s)):
from 40 to 100 phr of natural rubber or of a synthetic polyisoprene having a high cis-1,4 linkage content, and
from 60 to 0 phr of a polybutadiene and/or of a copolymer of butadiene and a vinyl-aromatic monomer, such as a styrene/butadiene copolymer.

According to one particular embodiment of the invention, the rubber composition of said intermediate layer comprises a reinforcing filler comprising carbon black or a blend of carbon black and a reinforcing inorganic filler, such as silica.

The present invention furthermore relates to a tire as described previously, intended to be fitted on motor vehicles of passenger-vehicle type, in which said bonding layer has a thickness of from 0.4 mm to 2 mm, and preferably of 0.6 mm to 1.2 mm.

Preferably, each of said sidewall inserts has a thickness of from 3 mm to 20 mm, and preferably of 5 mm to 14 mm.

According to one advantageous embodiment, said inner layer has a thickness of from 0.5 mm to 1.2 mm.

The reinforcement armature or reinforcement of the tires is currently—and most frequently—constituted by stacking one or more plies conventionally referred to as “carcass plies”, “crown plies”, etc. This manner of designating the reinforcement armatures is derived from the manufacturing process, which consists of producing a series of semi-finished products in the form of plies, provided with cord reinforcing threads which are frequently longitudinal, which products are then assembled or stacked in order to build a tire blank. The plies are produced flat, with large dimensions, and are subsequently cut according to the dimensions of a given product. The plies are also assembled, in a first phase, substantially flat. The blank thus produced is then shaped to adopt the toroidal profile typical of tires. The semi-finished products referred to as “finishing” products are then applied to the blank, so as to obtain a product ready to be vulcanized.

Such a type of “conventional” process involves, in particular for the phase of manufacture of the blank of the tire, the use of an anchoring element (generally a bead wire), used for anchoring or holding the carcass reinforcement in the zone of the beads of the tire. Thus, in this type of process, a portion of all the plies constituting the carcass reinforcement (or only a part thereof is turned up around a bead wire arranged in the tire bead. In this manner, the carcass reinforcement is anchored in the bead.

The general adoption of this type of conventional process in the industry, despite the numerous different ways of producing the plies and assemblies, has led the person skilled in the art to use a vocabulary which reflects this process; hence the generally accepted terminology, comprising in particular the terms “plies”, “carcass”, “bead wire”, “shaping” to designate the change from a flat profile to a toroidal profile, etc.

However, there are nowadays tires which do not, properly speaking, comprise “plies” or “bead wires” in accordance with the preceding definitions. For example, document EP 0 582 196 describes tires manufactured without the aid of semi-finished products in the form of plies. For example, the cords of the different reinforcement structures are applied directly to the adjacent layers of rubber mixes, the whole being applied in successive layers on a toroidal core having a shape which makes it possible to obtain directly a profile similar to the final profile of the tire being manufactured. Thus, in this case, there are no longer any “semi-finished products”, nor “plies”, nor “bead wires”. The base products, such as the rubber mixes and reinforcing threads in the form of cords or filaments, are applied directly to the core. As this core is of toroidal form, the blank no longer has to be shaped in order to change from a flat profile to a profile in the form of a torus.

Furthermore, the majority of the examples of embodiment of tires described in this document do not have the “conventional” upturn of the carcass ply around a bead wire. In these examples, this type of anchoring is replaced by an arrangement in which circumferential filaments are arranged adjacent to said sidewall reinforcement structure, the whole being embedded in an anchoring or bonding rubber composition.

There are also processes for assembly on a toroidal core using semi-finished products specially adapted for quick, effective and simple laying on a central core. Finally, it is also possible to use a mixture comprising both certain semi-finished products to produce certain architectural aspects (such as plies, bead wires, etc.), whereas others are produced from the direct application of mixes and/or reinforcing threads in the form of filaments or strips.

In the present document, in order to take into account recent technological developments both in the field of manufacture and in the design of products, the conventional terms such as “plies”, “bead wires”, etc., are advantageously replaced by neutral terms or terms which are independent of the type of process used. Thus, the term “carcass-type reinforcing thread” or “sidewall reinforcing thread” is valid as a designation for the reinforcement cords of a carcass ply in the conventional process, and the corresponding cords, generally applied at the level of the sidewalls, of a tire produced in accordance with a process without semi-finished products. The term “anchoring zone”, for its part, may equally well designate the “traditional” upturn of a carcass ply around a bead wire of a conventional process or the assembly formed by the circumferential filaments, the rubber composition and the adjacent sidewall reinforcement portions of a bottom zone produced with a process with application to a toroidal core.

In the present description, the term “cord” very generally designates both monofilaments and multifilaments or assemblies such as cables, plied yarns or alternatively any equivalent type of assembly, whatever the material and the treatment of these cords. This may, for example, involve surface treatments, coating or pre-sizing in order to promote adhesion to the rubber. The expression “unitary cord” designates a cord formed of a single element, without assembling. The term “multifilament”, in contrast, designates an assembly of at least two unitary elements to form a cable, plied yarn etc.

“Characteristics of the cord” is understood to mean, for example, its dimensions, its composition, its characteristics and mechanical properties (in particular the modulus), its chemical characteristics and properties, etc.

In the present description, “contact” between a cord and a layer of bonding rubber is understood to mean the fact that at least part of the outer circumference of the cord is in intimate contact with the rubber composition constituting the bonding rubber.

It is known that, conventionally, the carcass ply or plies is/are turned up about a bead wire. The bead wire then performs a carcass anchoring function. Thus, in particular, it withstands the tension which develops in the carcass cords for example under the action of the inflation pressure. The arrangement described in the present document makes it possible to provide a similar anchoring function. It is also known to use the bead wire of conventional type to perform the function of clamping the bead on a rim. The arrangement described in the present document also makes it possible to provide a similar clamping function.

“Sidewalls” refers to the portions of the tire, most frequently of low flexural strength, located between the crown and the beads. “Sidewall mix” refers to the rubber mixes located axially to the outside relative to the cords of the reinforcement structure of the carcass and to their bonding rubber. These mixes usually have a low elasticity modulus.

“Bead” refers to the portion of the tire adjacent radially internally to the sidewall.

“Modulus of extension ME10” of a rubber composition is understood to mean an apparent secant modulus of extension obtained at a uniaxial deformation of extension of the order of 10% measured at 23° C. in accordance with Standard ASTM D 412.

As a reminder, “radially upwards” or “radially upper” or “radially externally” means towards the largest radii.

A reinforcement or reinforcing structure of carcass type will be said to be radial when its cords are arranged at 90°, but also, according to the terminology in use, at an angle close to 90°.

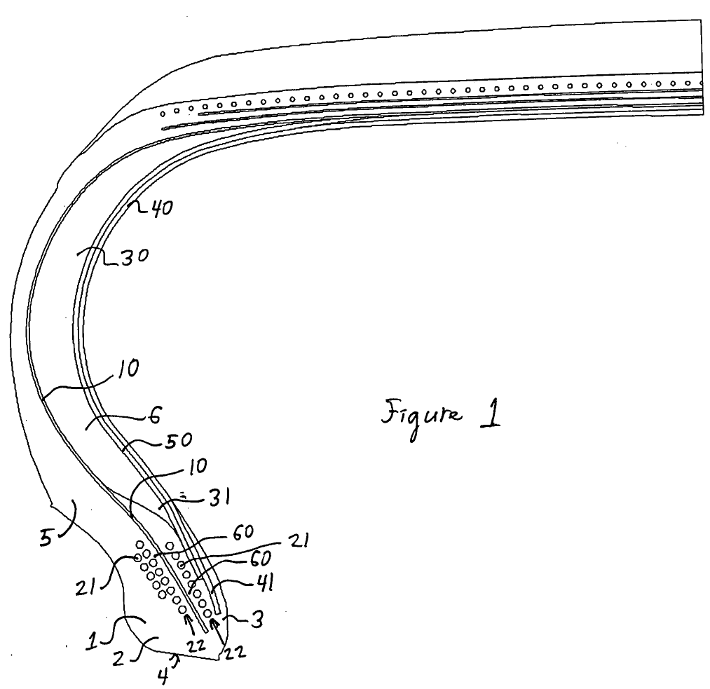

FIG. 1 shows the bottom zone, in particular the bead 1 of a first form of embodiment of the tire according to the invention. The bead 1 comprises an axially outer portion 2 which is provided and shaped so as to be placed against the flange of a rim. The upper portion, or radially outer portion, of the portion 2 forms a portion 5 adapted to the rim hook. This portion is frequently curved axially towards the outside, as illustrated in FIG. 1. The portion 2 ends radially and axially towards the inside in a bead seat 4 which is adapted to be placed against a rim seat. The bead also comprises an axially inner portion 3, which extends substantially radially from the seat 4 towards the sidewall 6.

The tire also comprises a reinforcement or reinforcing structure 10 of carcass type provided with reinforcing threads which are advantageously shaped in a substantially radial arrangement. This structure may be arranged continuously from one bead to the other, passing through the sidewalls and the crown of the tire, or alternatively it may comprise two or more parts, arranged for example along the sidewalls, without covering the entire crown.

In order to position the reinforcement cords as accurately as possible, it is very advantageous to build the tire on a rigid support, for example a central core which imposes the shape of its inner cavity. There are applied to this core, in the order required by the final architecture, all the constituents of the tire, which are arranged directly in their final position, without the profile of the tire having to be modified during building.

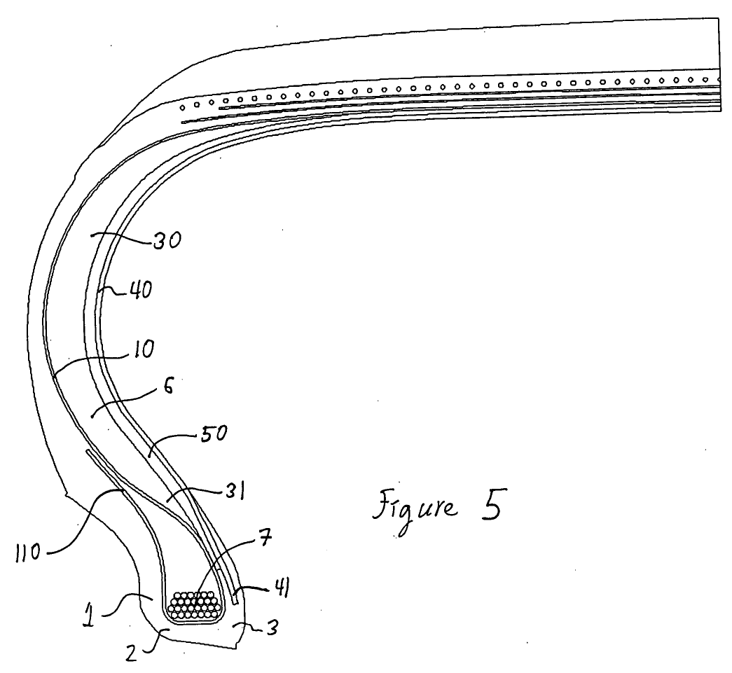

Two main types of anchoring of the carcass-type reinforcement structure are possible. Typically, as illustrated in FIG. 5, the upturn of said structure 10 around a bead wire 7 at the level of the bead 1 anchors the carcass-type reinforcement structure in the bead.

Otherwise, the anchoring function may be provided owing to an arrangement of circumferential cords, as illustrated for example in one of FIGS. 1 to 4. Circumferential cords 21, preferably arranged in the form of stacks 22, form an arrangement of anchoring cords, provided in each of the beads. These cords are preferably metallic, and possibly brass-coated. Various variants advantageously provide for cords which are textile in nature, such as, for example of aramid, nylon, PET, PEN, or hybrid, or of another nature, for example glass fibres. In each stack, the cords are advantageously substantially concentric and superposed.

In order to ensure perfect anchoring of the reinforcement structure, a stratified composite bead is produced. Within the bead 1, between the cord alignments of the reinforcement structure, there are arranged the circumferentially oriented cords 21. These are arranged in a stack 22 as in the drawings, or in a plurality of adjacent stacks, or in any suitable arrangement, depending on the type of tire and/or the desired characteristics.

The radially inner end portions of the reinforcement structure 10 cooperate with the cord windings. Anchoring of these portions in said beads is thus effected. In order to promote this anchoring, the space between the circumferential cords and the reinforcement structure is occupied by a bonding or anchoring rubber composition 60. It is also possible to provide for the use of a plurality of mixes having different characteristics, defining a plurality of zones, the combinations of mixes and the resultant arrangements being virtually unlimited. By way of non-limitative example, the modulus of extension of such a mix may reach or exceed 10 to 15 MPa, and even in some cases reach or even exceed 40 MPa.

The arrangements of cords may be arranged and manufactured in several ways. For example, a stack may advantageously be formed of a single cord wound (substantially at zero degrees) in a spiral over several turns, preferably from the smallest diameter towards the largest diameter. A stack may also be formed of a plurality of concentric cords laid one in another, so that rings of gradually increasing diameter are superposed. It is not necessary to add a rubber mix to impregnate the reinforcement cord, or the circumferential windings of cord.

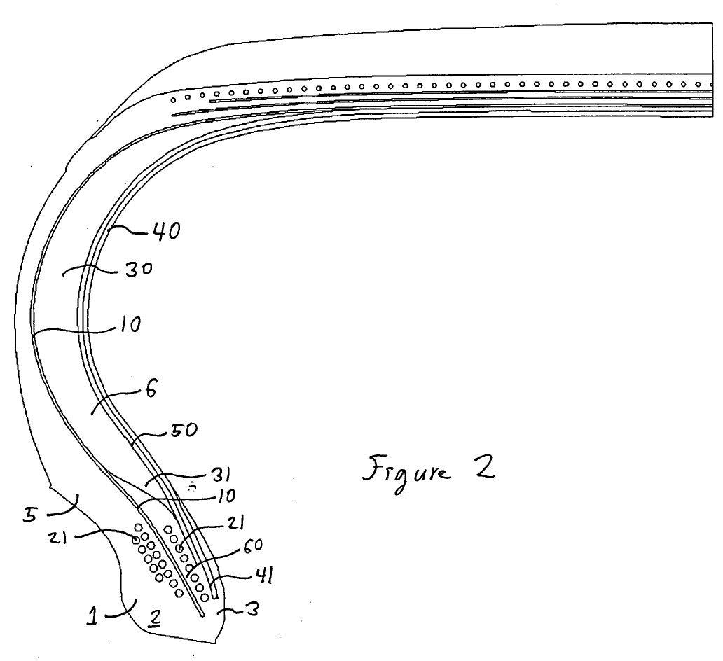

FIGS. 1 and 2 illustrate two first preferred embodiments according to the invention. A sidewall insert 30, formed of a substantially rigid rubber composition, extends substantially radially between the region of the base of the sidewall and the shoulder region of the tire. The main function of this insert is to enable the tire to support a certain load when used at low pressure, or even at zero pressure.

Although the figures illustrate an insert of large dimensions, a similar function could be provided by one or more inserts of substantially different, in particular smaller, size.

In a large proportion of the sidewall, the insert 30 occupies a width greater than 50% of the total thickness of the wall of the sidewall.

Axially internally relative to the insert 30, a layer of substantially impermeable rubber composition 40 extends advantageously over substantially all the inner portion of the tire. As the impermeable layer is the innermost, all the other layers benefit from the barrier effect thus created. The mix 30 is advantageously based on butyl rubber. Table I gives more details of the main constituent elements of this mix. We should furthermore point out the relatively low modulus of extension of this mix.

As illustrated in the various examples of embodiment, the layer 40 is preferably anchored in the axially inner portion of the bead. This resulting anchored portion 41 provides effective protection against any incipient cracks, or separations, etc.

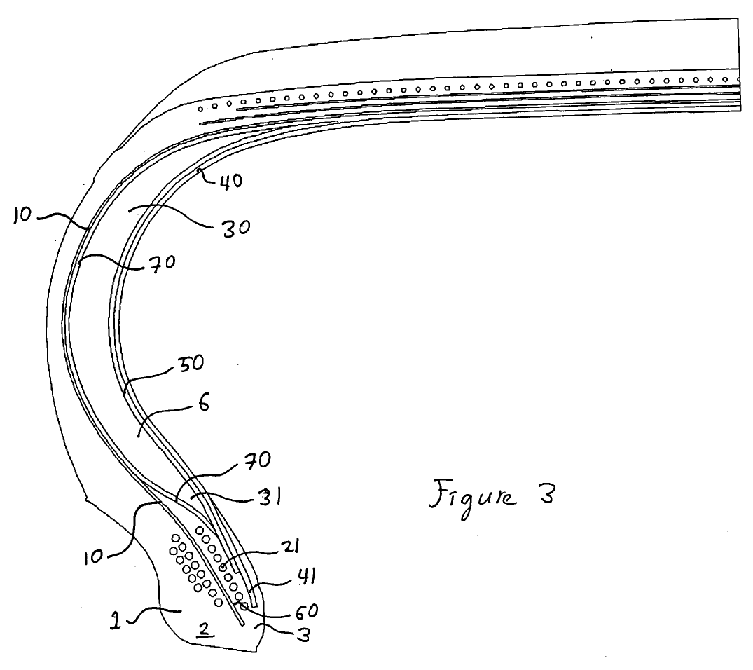

A layer of bonding mix 50 is arranged between the impermeable layer 40 and the insert 30. This layer is formed of a rubber composition of a modulus of extension which is substantially intermediate compared with the two types of materials surrounding it: namely on one hand the impermeable layer 40, of low modulus of extension, and the insert 30, of substantially high modulus of extension. In the examples of FIGS. 1 and 3, this layer extends substantially over the entire height of the insert 30 on each sidewall, and is interrupted in the crown zone. On the contrary, in the examples of FIGS. 2, 4 and 5 the layer 50 extends from one bead to the other, including into the crown zone. In FIG. 5, this same layer comprises a greater thickness than in the other examples illustrated.

The carcass-type reinforcement structure 10 runs along the sidewall along a preferred course close to said insert 30. Thus, in FIGS. 1 and 2, said structure 10 is laid axially externally relative to the insert 30 and runs advantageously in direct contact with the insert, over the greater part of the course of the sidewall. At the base of the sidewall, in the zone in which the insert narrows, the course of the structure 10 moves away from the insert. Advantageously, in the region of interface between the anchoring zone and the sidewall, the reinforcement structure 10 follows a course which is as direct as possible. In the examples illustrated, inclination of the anchoring zone, in particular of the stacks 22, enables the whole of the anchoring zone, and of the structure portion 10 located in this zone, to be substantially aligned with the axially outer edge of the insert 30, at the base thereof, in the portion located outside the narrowing zone 31. This type of arrangement permits effective taking-up of the forces of the carcass-type reinforcement structure by the anchoring zone, without creating a zone of stress concentration.

The direct contact between the reinforcement structure and the insert makes it possible to optimise the rigidity and mechanical strength characteristics of the sidewall.

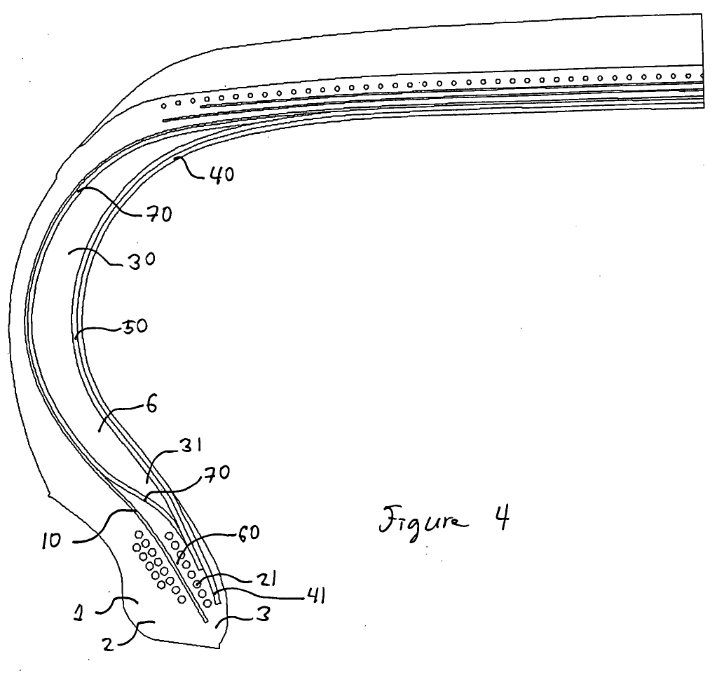

The variants of FIGS. 3 and 4 comprise an intermediate layer 70, formed of a rubber composition of a lower modulus of extension than the mixture of the insert 30, arranged between the insert 30 and the reinforcement structure 10. The cords of the structure 10 are not in direct contact with the insert 30, imparting a certain mechanical flexibility which contributes in particular to a good level of comfort and of durability/endurance. As illustrated in FIG. 5, the axially outer profile of the insert 30 is advantageously covered in its entirety by the intermediate layer 70. According to various variants, this layer 70 may either extend substantially radially between the bead and the base of the crown, or alternatively extend from one bead to the other, passing through the crown. Advantageously, the rubber composition of the intermediate layer 70 is the same as that of the bonding mix 50.

Table I shows examples of rubber compositions used for the different elements of the tire, preferred ranges of thickness, and several properties representative of these materials.

TABLE I
(phr: parts by weight per hundred parts of elastomer(s))

| | | Bonding | | Intermediate |
|---|---|---|---|---|
| | Inner layer | layer | Sidewall insert | layer |
| Ingredient A | Butyl rubber | (NR or IR)* | (NR or IR)* | (NR or IR)* |
| | (IIR) | 40-100 phr | 20-100 phr | 40-100 phr |
| | 40-100 phr | (preferably | | |
| | | >55%) | | |
| Ingredient B | (NR or IR)* | SBR 0-60 phr | SBR 0-50 phr | SBR 0-60 phr |
| | 0-60 phr | | | |
| Ingredient C | SBR 0-60 phr | BR 0-60 phr | BR 0-80 phr | BR 0-60 phr |
| Modulus (MPa) | 1.5-3.5 | 2-4 | 5-13 | 2-4 |
| Preferred | Between 0.5 | Between 0.4 | Between 3 | Between 0.2 |
| thickness (mm) | and 1.2 | and 2 | and 20 | and 1.5** |
| | | Preferably 0.6-1.2 | Preferably 5-14 | |

*natural rubber or synthetic polyisoprene having a high cis-1,4 linkage content
**the thickness is measured from the external part (or back) of the cords of the structure 10 (and not between the cords).

Finally, here are some illustrations, as non-limiting examples, of formulations of the various mixes:

Rubber Composition Forming Each Sidewall Insert:

the following mix formulation, in parts by weight per hundred parts of elastomer (phr):

| | |
|---|---|
| natural rubber: | 35 phr |
| polybutadiene: | 65 phr |
| carbon black N660: | 65 phr |
| “6PPD”: | 3 phr |
| sulphur: | 2.5 phr |
| “CBS”: | 3.5 phr |
| zinc oxide: | 3 phr |
| stearic acid: | 3 phr, |

where

“6PPD” N-(1,3-dimethylbutyl)-N′-phenyl-p-phenylenediamine, an agent which is both an antioxidant and an antiozonaut, and

“CBS” is N-cyclohexyl-benzothiazyl-sulphenamide, a vulcanization accelerator.

Rubber Composition Forming the Bonding Layer:

the following mix formulation, in parts by weight per hundred parts of elastomer (phr):

| | |
|---|---|
| natural rubber: | 75 phr |
| styrene/butadiene copolymer | 25 phr |
| carbon black N660: | 45 phr |
| aromatic oil: | 5 phr |
| “6PPD” | 1 phr |
| sulphur: | 2 phr |
| “CBS”: | 1 phr |
| zinc oxide: | 3 phr |
| stearic acid: | 1 phr |

Bonding Layer Having Improved Oxygen Fixation:

the following mix formulation, in parts by weight per hundred parts of elastomer (phr):

| | |
|---|---|
| natural rubber: | 75 phr |
| styrene/butadiene copolymer | 25 phr |
| carbon black N660: | 45 phr |
| aromatic oil: | 5 phr |
| “6PPD” | 1 phr |
| sulphur: | 3.5 phr |
| “CBS” | 1 phr |
| zinc oxide: | 7 phr |
| stearic acid: | 1 phr |
| cobalt salt | 0.2 phr |
| or | |
| natural rubber: | 75 phr |
| styrene/butadiene copolymer | 25 phr |
| carbon black N660: | 45 phr |
| aromatic oil: | 5 phr |
| “6PPD” | 1 phr |
| sulphur: | 3.5 phr |
| “CBS” | 1 phr |
| zinc oxide: | 7 phr |
| stearic acid: | 1 phr |
| iron salt | 0.02 phr |

where “phr” designates the percentage of elastomer by weight

It will be noted that the impermeable layer according to the invention could be formed of a rubber composition based on an elastomer other than butyl rubber (IIR), for example a halobutyl rubber (XIIR) or a paramethylstyrene/isobutylene copolymer.

FIG. 5 illustrates a variant embodiment in which the anchoring zone comprises a bead wire 7, formed of a multi-wire arrangement, around which the reinforcement structure 10 is wound, preferably starting from the axially inner side then moving towards the axially outer side, after passing radially internally relative to the bead wire. The free end 110 of the reinforcement structure 10 then re-ascends radially externally. This type of anchoring, which is conventionally known and widely used, is simple to produce, economic, and durable.

The industrial manufacture of a tire according to the invention may be carried out using several types of processes. Advantageously, a principle of laying on a central core is used which permits either individual laying of the constituent elements such as the rubber mixes and the reinforcing threads (cords) or alternatively the laying of semi-finished products such as reinforced rubber lamellae.

1. A tire suitable for extended-mobility travel, comprising at least one carcass-type reinforcement structure anchored on each side of said tire in a bead the base of which is intended to be mounted on a rim seat, each of said beads extending substantially radially externally in the form of sidewalls, the sidewalls radially towards the outside joining a tread, the carcass-type reinforcement structure extending circumferentially from the bead towards said sidewall, a crown reinforcement, each of the beads furthermore comprising an anchoring zone permitting the reinforcement structure to be held, each of said sidewalls being reinforced by a sidewall insert formed of rubber composition capable of bearing a load corresponding to part of the weight of the vehicle in a situation in which the inflation pressure is substantially reduced or zero, said tire furthermore comprising an inner layer formed of a rubber composition substantially impermeable to the inflation gas covering substantially the entire interior of said tire, from one sidewall to the other, a bonding layer formed of a rubber composition being arranged between each of said sidewall inserts and said inner layer.

2. The tire according to claim 1, in which said inner layer is extended along the sidewall radially internally to a level located in the junction zone between the radially inner portion of the sidewall insert and the radially outer portion of the anchoring zone.

3. The tire according to claim 1, in which said bonding layer is in direct contact with said inner layer on one hand and said insert on the other hand.

4. The tire according to claim 1, in which said bonding layer extends between the bead and the shoulder zone.

5. The tire according to claim 1, in which said bonding layer covers a surface which is substantially identical to that of the inner layer.

6. The tire according to claim 1, in which one end portion of said inner layer is anchored in the corresponding bead.

7. The tire according to claim 1, in which said bonding layer is formed of a rubber composition having a secant modulus of extension ME10 at 10% deformation, measured at 23° C. in accordance with Standard ASTM D 412, of from 2 to 4 MPa.

8. The tire according to claim 1, in which each of said sidewall inserts is formed of a rubber composition having a secant modulus of extension ME10 at 10% deformation, measured at 23° C. in accordance with Standard ASTM D 412, of from 5 to 13 MPa, and in which said inner layer is formed of a rubber composition having a secant modulus of extension ME10 at 10% deformation, measured at 23° C. in accordance with Standard ASTM D 412, of from 1.5 to 3.5 MPa.

9. The tire according to claim 1, in which the rubber composition of said bonding layer is based on one or more diene elastomers the molar ratio of units originating from conjugated dienes of which is at least equal to 30%.

10. The tire according to claim 9, in which the rubber composition of said bonding layer comprises (phr: parts by weight per hundred parts of elastomer(s)):
from 40 to 100 phr of natural rubber or of a synthetic polyisoprene having a high cis-1,4 linkage content, and
from 60 to 0 phr of a polybutadiene and/or of a copolymer of butadiene and a vinyl-aromatic monomer.

11. The tire according to claim 10, in which the rubber composition of said bonding layer comprises:
from 55 to 100 phr of said natural rubber or of said synthetic polyisoprene, and
from 45 to 0 phr of said polybutadiene and/or said butadiene copolymer.

12. The tire according to claim 9, in which the rubber composition of said bonding layer comprises a reinforcing filler comprising carbon black or a blend of carbon black and a reinforcing inorganic filler.

13. The tire according to claim 9, in which the rubber composition of said bonding layer comprises sulphur in a quantity equal to or greater than 2 phr (phr: parts by weight per hundred parts of elastomer(s)).

14. The tire according to claim 9, in which the rubber composition of said bonding layer furthermore comprises a metal salt provided to activate oxidation in this composition by trapping oxygen.

15. The tire according to claim 14, in which said salt is an iron (III) salt belonging to the group consisting of iron (III) acetylacetonate, iron (III) salts of carboxylic acids of formula Fe(CₙH₂ₙO₂)₃ where n is between 2 and 23, and iron (III) salts of an aromatic mono-carboxylic acid comprising one or more aromatic rings.

16. The tire according to claim 15, in which said iron (III) salt is present in the rubber composition of said bonding layer in a quantity of from 0.01 phr to 0.03 phr.

17. The tire according to claim 14, in which said salt is a cobalt salt.

18. The tire according to claim 17, in which said salt is cobalt naphthenate.

19. The tire according to claim 17, in which said cobalt salt is present in the rubber composition of said bonding layer in a quantity of from 0.1 phr to 0.3 phr.

20. The tire according to claim 1, intended to be fitted on motor vehicles of passenger-vehicle type, in which said bonding layer has a thickness of from 0.4 mm to 2 mm.

21. The tire according to claim 19, in which said bonding layer has a thickness of from 0.6 mm to 1.2 mm.
